(19) United States
(12) Patent Application Publication
(10) Pub. No.: US 2008/0072717 A1
(43) Pub. Date: Mar. 27, 2008

(54) Drywall screwdriver bit

(76) Inventor: William R. Stumpf, Kingsville, MD (US)

Correspondence Address: HARNESS, DICKEY & PIERCE, P.L.C., P.O. BOX 828, BLOOMFIELD HILLS, MI, 48303, US

(21) Appl. No.: 11/526,826

(22) Filed: Sep. 25, 2006

(51) Int. Cl. B25B 23/00

(52) U.S. Cl. 81/438; 81/460

(57) ABSTRACT

A screwdriver bit has a shank with a polygonal portion and two ends. A tip projects from each of the ends. The tip has a length substantially equal to a depth of a slot of a desired fastener head. The shaft ends nest on the fastener head upon insertion of the tip into the fastener head slot.

### FIELD

The present disclosure relates to a tool bit and, more particularly, to a dual end drywall screwdriver bit.

### BACKGROUND

Various types of tool bits exist in the art. Two ended tool bits, including screwdriver bits, exist in the art. Generally, the tool bits include a shank portion with a pair of tip portions. The tip portions may be planar, cruciform or Phillips, square, torques, hex, or the like. Also, two-ended tool bits may include various combinations of these types of tips on their ends. The two-ended tool bits generally include ends or tips which are elongated and may or may not include an additional cylindrical shaft portion to connect it with the shank. See FIGS. 7-11 for various types of tool bits. Accordingly, a substantial portion of the tip is not retained in the fastener head as illustrated in FIGS. 7-11 (in phantom) Thus, the two-ended tool bits are longer than a standard one end tool bit.

When utilizing a power drywall screwdriver or screw gun, screwdriver bits with a standard size, a standard one end tool about one inch in length, are utilized in the power screwdriver or screw gun. Due to the large amount of fasteners that are used to hang drywall, the screwdriver bits used to fasten the screws wear relatively quickly. Thus, when using a screw gun, the user must throw away the used screwdriver bits on a regular basis. However, due to their long length, two-end screwdriver bits are not conducive for use in power screwdrivers or screw guns. This is due to the fact that the two end screwdriver bit projects beyond the screw gun nose. In turn, the nose cannot be adjusted to compensate for the increased length and thus the screw gun cannot sink the screw head a desired depth into the drywall.

Thus, it would be desirable to have a screwdriver bit which is two ended and would have the same length as a standard single end screwdriver bit. This would enable the use of a two end screwdriver bit in a power screwdriver or screw gun.

### SUMMARY

The present disclosure provides a two end screwdriver bit which has a length equal to that of a standard single end screwdriver bit of about one inch. Thus, the present device doubles the life of a current drywall screwdriver bit. The present device maximizes the cross section of the shank at the working end of the tool bit to increase the strength of the working end of the bit. The screwdriver bit provides a reasonable manufacturing cost by utilizing a simple cold form, machining or forging process to form the ends of the shank.

According to a first aspect, a screwdriver bit comprises a shank with a polygonal portion and two ends. A tip is formed at each end. Each tip has a length substantially equal to a depth of a desired fastener slot. The cross-section of the shaft nests on the fastener head upon insertion of the tip into the fastener. The shank has a maximum cross section at the tip so that the tip has an increased strength. Also, the screwdriver bit has a length, about one inch, equal to a standard screwdriver bit with a single tip. Further, the tip has a cruciform or Phillips configuration. The dual end screwdriver bit is usable in a power drywall screwdriver or screw gun.

According to a second aspect, a screwdriver bit comprises a shank with a polygonal portion and two ends. A tip is formed at each end. The tip has a length to fit into a depth of a slot of a desired fastener head so that the shank and tips have a length substantially equal to a standard screwdriver bit having a single tip. The length of the bit from tip to tip is equal to a standard screwdriver bit which has a length of about one inch. The bit includes a pair of detents. Each detent is positioned a desired distance from its adjacent tip so that the detents assist in indexing or coupling the bit in a screw gun.

According to a third aspect, a method of forming a screwdriver bit comprises forming a shank having two ends with a length equal to a standard length of a screwdriver bit with a single tip. A working end is formed on each end of the shank. The double end screwdriver bit has a length, about one inch, equal to a standard length of a single end screwdriver bit. The working end has a length substantially equal to a depth of a desired fastener slot. The working end is formed with a cruciform or Phillips configuration.

From the following detailed description taken in conjunction with the accompanying drawings and claims, other objects and aspects of the present disclosure will become apparent to those skilled in the art.

### DRAWINGS

The drawings described herein are for illustration purposes only and are not intended to limit the scope of the present disclosure in any way.

FIG. 1 is a perspective view of a screwdriver bit.

FIG. 2 is a side view of the screwdriver bit of FIG. 1.

FIG. 3 is a front plan view of the screwdriver bit of FIG. 1.

FIG. 4 is a side view partially in section of the screwdriver bit in a fastener slot.

FIG. 5 is a perspective view of another screwdriver bit.

FIG. 6 is a side view of another screwdriver bit according to the present disclosure.

FIGS. 7-11 are elevation views of prior art tool bits.

### DETAILED DESCRIPTION

The following description is merely exemplary in nature and is not intended to limit the present disclosure, application, or uses.

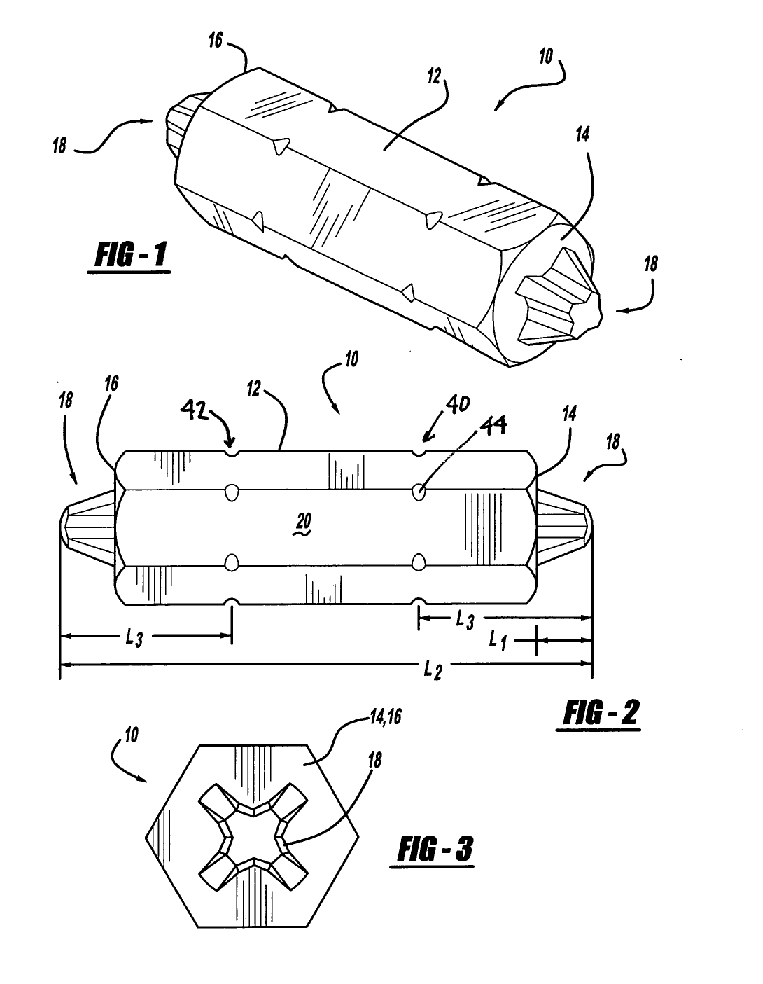

Turning to FIGS. 1-5, a drywall screwdriver bit is illustrated and designated with the reference numeral 10. The drywall screwdriver bit 10 includes a shank 12 with two ends 14 and 16. Each end 14 and 16 includes a working tip 18.

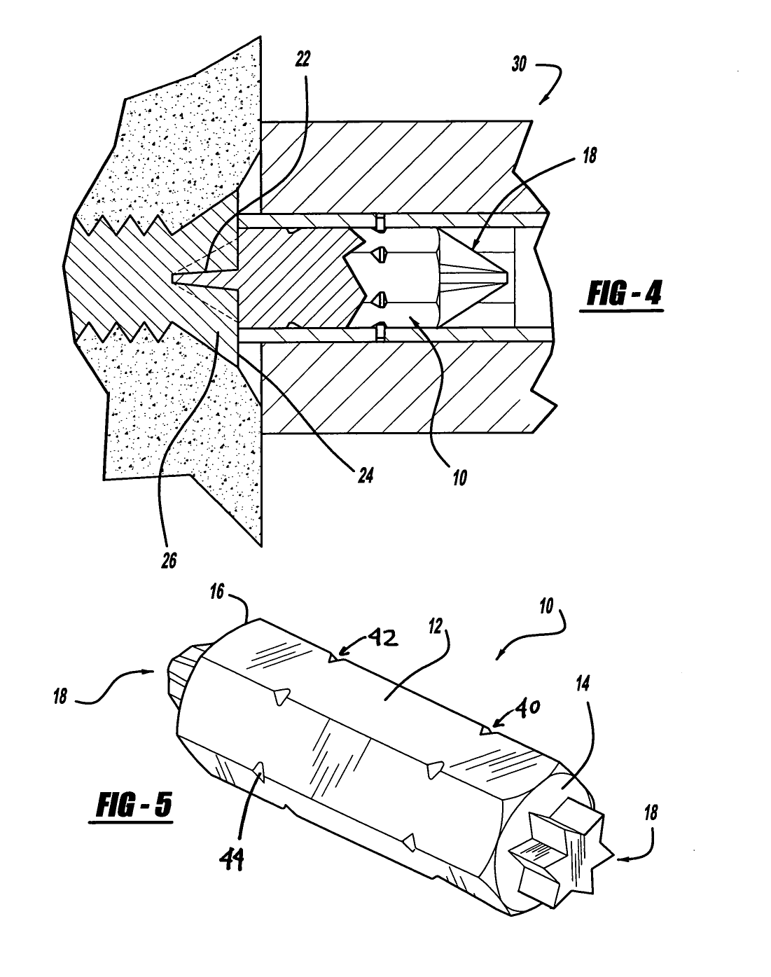

The shank 12, as shown, has a hex configuration portion having a plurality of flat surfaces 20. The shank 12 could also be of other polygonal designs, partial polygonal with cylindrical ends, or the like having flat bearing surfaces. The shank ends 16 and 14 have a hexagonal cross-section, as best illustrated in FIG. 3. The ends 14 and 16 are substantially flat or planar. The tips 18 extend from the hexagonal cross section of the ends 14 and 16.

The tips 18 have a Phillips or cruciform configuration. However, other types of configurations, such as flat, square, torx, hex, or a combination thereof, may be used (see FIG. 5). The tips 18 have a desired length L₁. The length L₁ corresponds to a depth of a drywall fastener head slot 22, as seen in FIG. 4. The length L₁ is generally between about ⅛″ to ¼″ inch. The tips 18 therefore have a length which is equivalent to a working depth of a fastener head slot configuration. Thus, the hexagonal cross-section ends 14, 16 nests or rests on the planar surface 24 of the fastener head 26 of the drywall fastener 20, as seen in FIG. 4. The tips 18, by having their desired length equal to only a working depth of the slot 22, enable the length L₂, about one inch, of the screwdriver bit 10 to be equal to the length of a standard screwdriver bit which includes a single tip. Thus, the present screwdriver bit 10 provides a dual tip on a single tip standard length screwdriver bit. This enables the screwdriver bit to be utilized in power drywall screwdrivers 30 or screw guns without modifying the nose of the power screwdriver or screw gun. Also, the screwdriver bit 10 could have a single tip 18 and have a standard single tip length.

Also, the shank 12 includes a pair of detents 40 and 42. The detents 40 and 42 are circumferentially positioned about the shank 12. The detents 40 and 42 include notches 44 at each apex of the junctures of each of the planar surfaces 20 of the shank. Thus, the detents 40 and 42 include a plurality of notches 44 which are circumferentially positioned about the shank 12. The detents 40 and 42 are positioned a desired distance from each tip L₃. Thus, the detents 40 and 42 are in alignment in a screw gun to index or assist in retaining the drill bit into the screw gun as seen in FIG. 4. Ordinarily, the detents are positioned at about 5/16 inch from the free extending end of the tip.

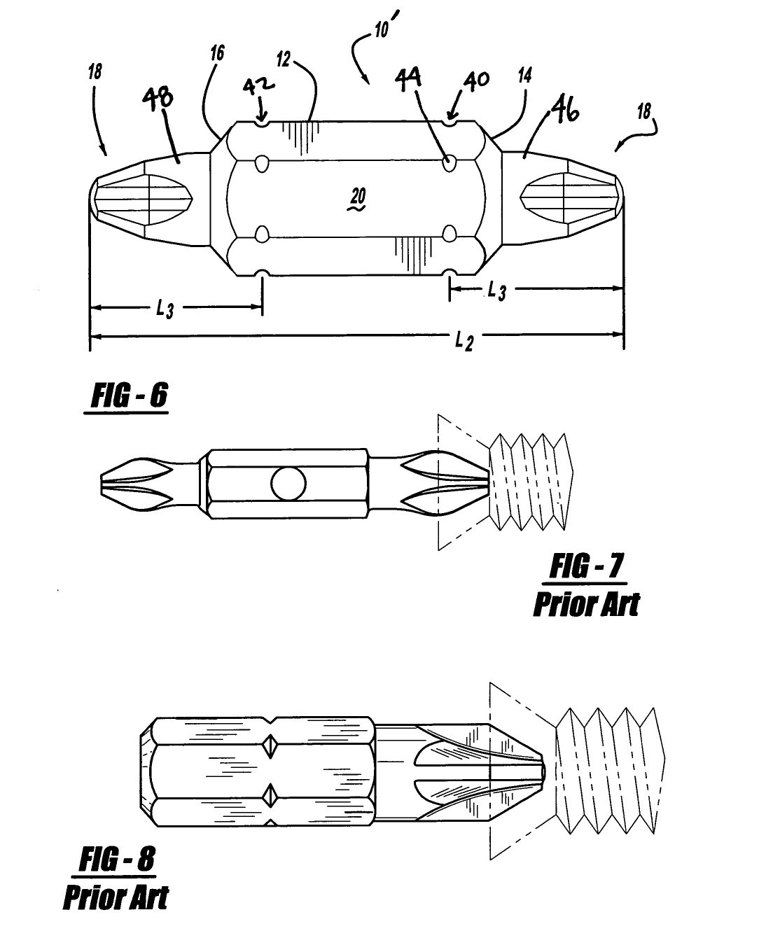

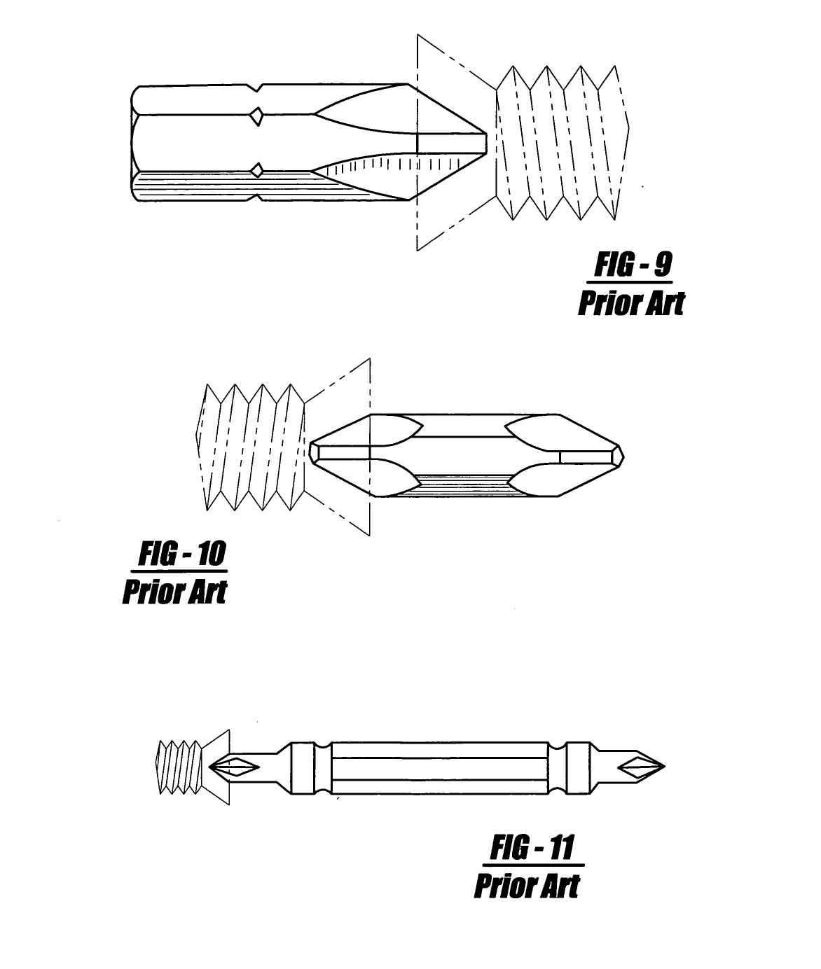

FIG. 6 illustrates another bit 10′ in accordance with the present disclosure. The drill bit 10′ utilizes the same numbers as that previously disclosed. Here, the screwdriver bit 10′ has an appearance like those in the art. However, the drill bit still has a length L₂ equal to about 1 inch. The screwdriver bits include a cylindrical portion 46, 48 between the ends of the shank 14 and 16 and the tips 18.

The tip 18, having its cruciform or Phillips configuration, is stamped, machined, forged or cold formed onto the hexagonal shank. The hexagonal cross-section ends 14, 16 provide the cruciform shaped tip 18 with additional strength. This is due to the fact that the tips 18 have a short length as well as they are formed directly out of the hexagonal shaft end.

The screwdriver bit is generally manufactured by forming a hexagonal blank into a desired length to form a screwdriver bit with a length of a standard single ended screwdriver bit. The ends of the shank are cold formed, machined, forged, or stamped to form a tip, in this instance, a cruciform or Phillips tip. The tips 18 are formed such that the length of the cruciform is substantially equal to the depth of the slots of a drywall fastener heads. Thus, the length, after forming, of the double end screwdriver bit is equal to the standard length, about one inch, of a screwdriver bit having a single end.

The description of the invention is merely exemplary in nature and, thus, variations that do not depart from the gist of the invention are intended to be within the scope of the invention. Such variations are not to be regarded as a departure from the spirit and scope of the disclosure.

What is claimed is:

1. A screwdriver bit comprising:
a shank having a polygonal portion and two ends;
a tip at at least one of said ends, said tip having a length substantially equal to a depth of a slot of a desired fastener head so that said end of said shank nest on the fastener head upon insertion of said tip.

2. The screwdriver bit according to claim 1, wherein said shank has a maximum cross section at said tip so that said tip has an increased strength.

3. The screwdriver bit according to claim 1, wherein said screwdriver bit has a length equal to a standard screwdriver bit having a single tip.

4. The screwdriver bit according to claim 1, wherein said tip has a cruciform configuration.

5. The screwdriver bit according to claim 3 wherein said screwdriver bit is usable in a power screwdriver screw gun.

6. The screwdriver bit according to claim 1, wherein said tip has a length between ⅛″ to ¼″.

7. The screwdriver bit according to claim 1, wherein said at least one tip may have a flat, cruciform or Philips, square, torx, hex or the like configuration or combinations thereof.

8. The screwdriver bit according to claim 1, wherein a tip is at both ends of said shank.

9. A method of forming a screwdriver bit comprising:
forming a shank having two ends and a desired length for forming a screwdriver bit having a length equal to a standard length of screwdriver bit having a single tip;
forming a working end on each end of said shank such that said screwdriver bit with said working ends has a length substantially equal to the standard length of the screwdriver bit having a single tip.

10. The method of claim 9, further comprising forming a cruciform configuration as said working end.

11. The method of claim 9, further comprising forming said working end on each end of said shank such that said working end has a length substantially equal to a depth of a desired fastener head slot.

12. A screwdriver bit comprising:
a shank having a polygonal portion and two ends;
a tip at each said end, said tip having a length for fitting a depth of a slot of a desired fastener head so that said shank and tips have a length substantially equal to a standard screwdriver bit having a single tip.

13. The screwdriver bit according to claim 12, wherein said screwdriver bit length is about one inch which is equal to a standard screwdriver bit having a single tip.

14. The screwdriver bit according to claim 12, wherein said tip has a cruciform configuration.

15. The screwdriver bit according to claim 14 wherein said screwdriver bit is usable in a power screwdriver screw gun.

16. The screwdriver bit according to claim 12, wherein said tips may have a flat, cruciform or Philips, square, torx, hex or the like configuration or combinations thereof.

17. The screwdriver bit according to claim 12, further comprising a pair of detents.

18. The screwdriver bit according to claim 17, wherein each detent is positioned a desired distance from the tip to index or retain the screwdriver bit in a screw gun.
